(19) United States
(12) Patent Application Publication
(10) Pub. No.: US 2002/0041954 A1
(43) Pub. Date: Apr. 11, 2002

(54) Impact-resistant sandwich structural element

(76) Inventors: Paul Henrichs, Bergisch Gladbach (DE); Heinz Hausmann, Leichlingen (DE)

Correspondence Address: BAYER CORPORATION, PATENT DEPARTMENT, 100 BAYER ROAD, PITTSBURGH, PA, 15205, US

(21) Appl. No.: 09/900,783

(22) Filed: Jul. 6, 2001

(30) Foreign Application Priority Data
Jul. 10, 2000 (DE) 10033260.9

(51) Int. Cl. A63B 39/00; B32B 3/26

(52) U.S. Cl. 428/316.6; 156/145

(57) ABSTRACT

Impact-resistant sandwich structural elements containing at least one solid thermo-setting polyurethane layer and at least one polyurethane elastomer layer and a process for their preparation are disclosed. The elements are useful in preparing sanitary fittings, swimming pools, domestic refrigerators, wall panels, vehicles or furniture, in the construction industry, in waste-water technology or in coach-building.

The invention relates to impact-resistant sandwich structural elements containing at least one solid thermosetting polyurethane layer and at least one polyurethane elastomer layer, to a process for their preparation and to the use of such sandwich structural elements in sanitary fittings, swimming pools, domestic refrigerators, wall panels, vehicles or furniture, in the construction industry, in waste-water technology or in coach-building.

In the disclosure of EP-A 589 343, sanitary fittings whose visible and use surface consists of polymethyl methacrylate are provided with a supporting polyurethane sandwich structure, the layers being applied layer by layer directly to the preformed polymethyl methacrylate substrate by means of a two-component mixing nozzle. In order to improve adhesion, the polymethyl methacrylate surface to be coated is first coated with a solution of an uncrosslinked elastic polymeric resin having a pronounced crystallisation tendency. This solution may also be a polyurethane solution.

WO 94/14587 discloses sandwich structural elements consisting of two solid reactive plastics layers and an intermediate reactive plastics foam layer. The sandwich structural elements are produced from two-component reaction plastics by the spray application of corresponding reactive mixtures layer by layer onto a substrate. Heat hardenable resins are used as the reactive plastic; polyureas or mixtures of polyurethanes urethanes and polyesters are proposed.

From EP-A 728 574 there are known sandwich structural elements that consist of solid polyurethane layers containing from 15 to 55 wt. % mica or talcum and of polyurethane foam layers, and that are obtained by application layer by layer to a substrate.

It has been found in practical application that the sandwich structural elements of the prior art exhibit inadequate impact resistance, which is noticeable particularly in the case of thin elements. Accordingly, for example in the case of sanitary fittings, breaking of the wall may occur, with an increased risk of injury.

It has now been found that an article comprising a plurality of layers having markedly improved impact resistance can be obtained by combining a solid thermosetting polyurethane layer with an underlying layer of a crosslinked polyurethane elastomer.

Accordingly, the invention provides sandwich structural elements having the following layer sequence:

1. optionally a decorative surface layer, particularly a hard surface layer (e.g. PMMA, veneer, lacquer, gel-coat, ABS, polycarbonate, polystyrene, PVC, ASA),

2. a solid thermosetting polyurethane layer,

3. a polyurethane elastomer layer,

4. optionally a polyurethane foam layer,

5. a further solid thermosetting polyurethane layer,

6. optionally a substrate of paper, plastics (e.g. GFRP (glass fiber reinforced polyester), films, stone, wood or metal (e.g. steel) or a further decorative surface layer.

Further preferred layer sequences are decorative layer/solid thermosetting PU layer/PU elastomer layer/PU foam layer, or decorative layer/solid thermosetting PU layer/PU elastomer layer/PU foam layer/solid thermosetting PU layer/(optional decorative layer), or decorative layer/solid thermosetting PU layer/PU elastomer layer/solid thermosetting PU layer.

According to the invention there are suitable as the polyurethane reactive mixture for the preparation of the polyurethane layers all rapidly reacting polyurethane reactive mixtures, as have been developed particularly for the reaction injection moulding technique (RIM technique). There is used as the isocyanate component preferably a semi-prepolymer based on MDI and polyether polyols having an OH number of from 40 to 600, particularly preferably from 150 to 400, and having from 10 to 33 wt. %, particularly preferably from 20 to 28 wt. %, NCO groups.

Also suitable as the isocyanate reactant are aliphatic, cycloaliphatic, araliphatic, aromatic and heterocyclic polyisocyanates, as are described, for example, by W. Siefken in Justus Liebigs Annalen der Chemie, 562, pages 75 to 136, for example those, of the formula

Q(NCO)ₙ

in which n—from 2 to 4, preferably 2, and Q represents an aliphatic hydrocarbon radical having from 2 to 18 carbon atoms, preferably from 6 to 10 carbon atoms, a cycloaliphatic hydrocarbon radical having from 4 to 15 carbon atoms, preferably from 5 to 10 carbon atoms, an aromatic hydrocarbon radical having from 6 to 15 carbon atoms, preferably from 6 to 13 carbon atoms, or an araliphatic hydrocarbon radical having from 8 to 15 carbon atoms, preferably from 8 to 13 carbon atoms, for example ethylene diisocyanate, 1,4-tetramethylene diisocyanate, 1,6-hexamethylene diisocyanate (HDI), 1,12-dodecane diisocyanate, cyclobutane 1,3-diisocyanate, cyclohexane 1,3- and 1,4-diisocyanate and any desired mixtures of those isomers, 1-isocyanato-3,3,5-trimethyl-5-isocyanatomethyl-cyclohexane (DE-AS 1 202 785, USA 3 401 190), 2,4- and 2,6-hexahydrotoluylene diisocyanate and any desired mixtures of those isomers, hexahydro-1,3- and -1,4-phenylene diisocyanate, perhydro-2,4′- and -4,4′-diphenylmethane diisocyanate, 1,3- and 1,4-phenylene diisocyanate (DE-OS 196 27 907), 1,4-durene diisocyanate (DDI), 4,4′-stilbene diisocyanate (DE-OS 196 28 145), 3,3′-dimethyl-4,4′-biphenylene diisocyanate (TODI, DE-OS 195 09 819), 2,4- and 2,6-toluylene diisocyanate (TDI) and any desired mixtures of those isomers, diphenylmethane 2,4′- and/or 4,4′-diisocyanate (MDI), isophorone diisocyanate (IPDI) or naphthylene 1,5-diisocyanate (NDI).

There are also suitable according to the invention, for example: triphenylmethane 4,4′,4″-triisocyanate, polyphenyl-polymethylene polyisocyanates, as are obtained by aniline-formaldehyde condensation and subsequent phosgenation and described, for example, in GB-B 874 430 and GB-B 848 671, m- and p-isocyanatophenylsulfonyl isocyanates according to U.S. Pat. No. 3,454,606, perchlorinated aryl polyisocyanates, as are described in U.S. Pat. No. 3,277,138, polyisocyanates containing carbodiimide groups, as are described in U.S. Pat. No. 3,152,162 and in DE-OS 25 04 400, 25 37 685 and 25 52 350, norbornane diisocyanates according to U.S. Pat. No. 3,492,301, polyisocyanates containing allophanate groups, as are described in GB-A 994 890, BE-PS 761 626 and NL-A 7 102 524, polyisocyanates containing isocyanurate groups, as are described in DE-PS 10 22 789, 12 22 067 and 1027 394 and in DE-OS 1 929 034 and 2 004 048, polyisocyanates containing urethane groups, as are described, for example, in BE-PS 752 261 or in U.S. Pat. Nos. 3,394,164 and 3,644,457, polyisocyanates containing acylated urea groups according to DE-PS 1 230 778, polyisocyanates containing biuret groups, as are described in U.S. Pat. Nos. 3,124,605, 3,201,372 and 3,124,605 and in GB-B 889 050, polyisocyanates prepared by telomerisation reactions, as are described in U.S. Pat. No. 3,654,106, polyisocyanates containing ester groups, as are mentioned in GB-B 965 474 and 1072 956, in U.S. Pat. No. 3,567,763 and in DE-PS 12 31 688, reaction products of the above-mentioned isocyanates with acetals according to DE-PS 1 072 385, and polyisocyanates containing polymeric fatty acid esters according to US-B 3 455 883.

It is also possible to use the distillation residues, containing isocyanate groups, that are formed in the commercial preparation of isocyanates, optionally dissolved in one or more of the above-mentioned polyisocyanates. It is also possible to use any desired mixtures of the above-mentioned polyisocyanates.

There are preferably used polyisocyanates that are readily obtainable commercially, for example 2,4- and 2,6-toluylene diisocyanate and any desired mixtures of those isomers (“TDI”), polyphenyl-polymethylene polyisocyanates, as are prepared by ani-line-formaldehyde condensation and subsequent phosgenation (“crude NMI”), and polyisocyanates containing carbodiimide groups, urethane groups, allophanate groups, isocyanurate groups, urea groups or biuret groups (“modified polyisocyanates”), particularly those modified polyisocyanates that are derived from 2,4- and/or 2,6-toluylene diisocyanate or from 4,4′- and/or 2,4′-diphenylmethane diisocyanate. Naphthylene 1,5-diisocyanate and mixtures of the mentioned polyisocyanates are also highly suitable.

Suitable blowing agents are water as a chemical blowing agent that produces carbon dioxide or, as physical blowing agents, the low-boiling liquids conventionally used in polyurethane chemistry. Also suitable are gases, for example carbon dioxide, that are soluble under pressure in at least one of the components and that are liberated, with foaming, as the pressure is relieved during discharge from the mixing unit. The concomitant use of other fillers, such as glass fibres, metal particles or colouring pigments, or of fillers used to increase resistance to fire, such as melamine resins or phosphorus compounds, is also not ruled out.

The components of the polyurethane reactive mixture are preferably mixed with one another in a ratio such that the isocyanate number of the mixture is from 90 to 130.

Preference is given to the use of systems that reach the non-tacky state within a period of from 1 to 5 minutes, preferably from I to 3 minutes, after mixing.

Catalysts known to the person skilled in the art may be used in the polyurethane reactive mixtures, for example tertiary amines, such as triethylamine, tributylamine, N-methyl-morpholine, N-ethyl-morpholine, N,N,N,N′-tetramethyl-ethylenediamine, pentamethyl-diethylene-triamine and higher homologues (DE-OS 26 24 527 and 26 24 528), 1,4-diaza-bicyclo-(2.2.2)-octane, N-methyl-N′-dimethylaminoethyl-piperazine, bis-(dimethylaminoalkyl)-piperazines (DE-OS 26 36 787), N,N-dimethylbenzylamine, N,N-dimethylcyclohexylamine, N,N-diethylbenzylamine, bis-(N,N-diethylaminoethyl) adipate, N,N,N′,N′-tetramethyl-1,3-butanediatnine, N,N-di-methyl-p-phenyl-ethyl-amine, bis-(dimethylaminopropyl)-urea, 1,2-dimethylimidazole, 2-methylimidazole, monocyclic and bicyclic amidines (DE-OS 17 20 633), bis-(dialkylamino)-alkyl ethers (U.S. Pat. No. 3,330,782, DE-AS 10 30 558, DE-OS 18 04 361 and 26 18 280) as well as tertiary amines containing amide groups (preferably formamide groups) according to DE-OS 25 23 633 and 27 32 292). There are suitable as catalysts also Mannich bases, known per se, of secondary amines, such as dimethylamine, and aldehydes; preferably formaldehyde, or ketones, such as acetone, methyl ethyl ketone, or cyclohexanone and phenols, such as phenol, nonylphenol or bisphenol. Tertiary amines containing hydrogen atoms that are active towards isocyanate groups as catalyst are, for example, triethanolamine, tri-isopropanolamine, methyl-diethanolamine, N-ethyl-diethanolamine, N,N-di-methyl-ethanolamine, reaction products thereof with alkylene oxides, such as propylene oxide and/or ethylene oxide, as well as secondary-tertiary amines according to DE-OS 27 32 292. There may also be used as catalysts sila-amines with carbon-silicon bonds, as are described in U.S. Pat. No. 3,620,984, for example 2,2,4-trimethyl-2-silamorpholine and 1,3-diethylaminomethyl-tetramethyl-di-siloxane. Nitrogen-containing bases such as tetraalkylammonium hydroxides, and also alkali metal hydroxides, such as sodium hydroxide, alkali metal phenolates, such as sodium phenolate, or alkali metal alcoholates, such as sodium methoxide are also suitable. Hexahydrotriazines may also be used as catalysts (DE-OS 17 69 043). The reaction between NCO groups and Zerewitinoff-active hydrogen atoms is also greatly accelerated by lactams and azalactams, there first forming an associate between the lactam and the compound having an acid hydrogen. Such associates and their catalytic action are described in DE-OS 20 62 286, 20 62 289, 21 17 576, 21 29 198, 23 30 175 and 23 30 211. Organometallic compounds, particularly organotin compounds, may also be used according to the invention as catalysts. Organotin compounds such as di-n-octyltin mercaptide (U.S. Pat. No. 3,645,927), preferably tin(II) salts of carboxylic acids, such as tin(II) acetate, tin(II) octoate, tin(II) ethyl-hexoate and tin(II) laurate, and tin(IV) compounds, for example dibutyltin oxide, dibutyltin dichloride, dibutyltin diacetate, dibutyltin dilaurate, dibutyltin maleate or dioctyltin diacetate are also suitable. Organometallic compounds of zinc, bismuth, iron or other transition metals may also be used.

Of course, all the above-mentioned catalysts may be used in the form of mixtures. Combinations of organometallic compounds and amidines, amino-pyridines or hydrazinopyridines (DE-OS 24 34 185, 26 01 082 and 26 03 834) are of particular interest.

Further representatives of catalysts that may be used according to the invention and details regarding the mode of action of the catalysts are described in R. Vieweg, A. Höchtlen (eds.): “Kunststoff-Handbuch”, Vol. VII, Carl-Hanser-Verlag, Munich 1966, p. 96-102.

The catalysts or catalyst combinations are generally used in an amount of approximately from 0.001 to 10 wt. %, particularly from 0.01 to I wt. %, based on the total amount of compounds having at least two hydrogen atoms that are reactive towards isocyanates.

Additives may optionally be incorporated into the reaction mixture. Mention may be made, for example, of surface-active additives, such as emulsifiers, foam stabilisers, cell regulators, flame retardants, nucleating agents, oxidation retardants, stabilisers, lubricants and mould-release agents, colouring agents, dispersion aids, viscosity modifiers, thixotropic agents (e.g. chemical thixotropic agents, such as DETDA), water-binding agents, such as zeolites or carbodiimides, anti-foams (de-foamers and anti-foamers), spreading agents, waterproofing agents and pigments. Suitable emulsifiers are, for example, the sodium salts of castor oil sulfonates or salts of fatty acids with amines such as oleic acid diethylamine or stearic acid diethanolamine. There may also be used concomitantly as surface-active additives alkali metal or ammonium salts of sulfonic; acids, such as, for example, of dodecylbenzenesulfonic acid or dinaphthylmethanedisulfonic acid, or of fatty acids such as ricinoleic acid or of polymeric fatty acids, also alkyl aryl polyglycol ethers and acetates. Suitable foam stabilisers are in particular polyether siloxanes, especially water-soluble examples thereof. The structure of such compounds is generally such that a copolymer of ethylene oxide and propylene oxide is bonded to a polydimethylsiloxane radical.

Such foam stabilisers are described, for example, in U.S. Pat. Nos. 2,834,748, 2,917,480 and 3,629,308. Of particular interest are polysiloxane-polyoxyalkylene copolymers according to DE-OS 25 58 523 which are branched many times via allophanate groups. Also suitable are other organopolysiloxanes, ethoxylated alkylphenols, ethoxylated fatty alcohols, paraffin oils, castor oil and ricinoleic acid esters, Turkey-red oil and groundnut oil, and cell regulators such as paraffins, fatty alcohols and dimethylpolysiloxanes. For improving the emulsifying action, the dispersion of the filler, the cell structure and/or for stabilisation thereof oligomeric polyacrylates having polyoxyalkylene and fluoroalkane radicals as side groups are also suitable. The surface-active substances are usually employed in amounts of from 0.01 to 5 parts by weight, based on 100 parts by weight of the higher molecular weight polyhydroxyl compounds b). It is also possible to add reaction retardants, for example substances that have an acid reaction, such as hydrochloric acid, or organic acids and acid halides, also cell regulators known per se, such as paraffins or fatty alcohols or dimethylpolysiloxanes, as well as pigments or colouring agents and flame retardants known per se, for example trischloroethyl phosphate, tricresyl phosphate or ammonium phosphate and polyphosphate, also stabilisers against the effects of ageing and weathering, plasticisers, and substances having a fungistatic and bacteriostatic action.

Further examples of surface-active additives and foam stabilisers as well as cell regulators, reaction retardants, stabilisers, flame-inhibiting substances, plasticisers, colouring agents and fillers as well as substances having a fungicidal or fungistatic, bactericidal or bacteriostatic action that may optionally be used concomitantly according to the invention, and details regarding the use and the mode of action of such additives, are described in R. Vieweg. A. Hochtlen (eds.): “Kunststoff-Hand-buch”, Vol. VII, Carl-Hanser-Verlag, Munich 1966, p. 103-113.

The solid thermosetting polyurethane layers are prepared from a two-component polyurethane formulation; preference is given to the use of a polyurethane that is obtained by reaction of an isocyanate component, which is particularly preferably a semi-prepolymer based on MDI and polyether polyols having an OH number of from 40 to 600, in particular from 150 to 400, and having from 10 to 33 wt. %, in particular from 20 to 28 wt. %, NCO groups, with polyether polyols having a functionality of higher than 2. Those polyether polyols are preferably polyethers prepared by alkoxylation of diamines such as ethylenediamine or o-toluylenediamine or sugar alcohols such as sorbitol. However, polyether polyols obtained by alkoxylation of ethylene glycol, diethylene glycol, glycerol or trimethylolpropane may also be used concomitantly. The polyol component used is preferably a polyether polyol having an OH number of from 150 to 400. The solid thermosetting polyurethane layers may have a thickness of from 0.8 to 8 mm, preferably from 1.5 to 3 mm, particularly preferably from 2 to 3 mm.

In a particularly preferred embodiment, the solid thermosetting polyurethane layer contains from 10 to 55 wt. %, preferably from 25 to 50 wt. %, in particular from 30 to 40 wt. %, mica or talcum as filler. The mean particle size of the mica or talcum may be from 5 to 80 m.

The polyurethane elastomer layer consists of crosslinked, compact or cellular PU (polyurethane) elastomers. The preparation of compact or cellular, for example microcellular, PU elastomers has long been known from a large number of patent and literature publications. An overview of PU elastomers, their properties and uses is given, for example, in G. W. Becker, D. Braun (eds.): “Kunststoff-Handbuch”, Vol. 7, 3rd edition, Carl-Hanser-Verlag, Munich, Vienna 1993, p. 417-513.

MDI or TDI is preferably used as the isocyanate component. The PU elastomers are prepared particularly preferably by the prepolymer process, in which there is advantageously prepared in the first step, from a higher molecular weight polyhydroxyl compound and at least one di- or polyisocyanate, a polyaddition adduct that contains isocyanate groups and preferably has an NCO content of from 10 to 30 wt. %, in particular from 10 to 20 wt. %. The isocyanate component used for the preparation of the elastomer layer is preferably the same as that used for the preparation of the solid thermosetting polyurethane layer(s). In the second step, solid PU elastomers can be prepared from such prepolymers containing isocyanate groups by reaction with low molecular weight chain-lengthening agents and/or crosslinking agents and/or higher molecular weight polyhydroxyl compounds as well as chain-regulating agents.

Suitable higher molecular weight polyhydroxyl compounds are those having at least two H atoms that are reactive towards isocyanate groups; polyester polyols and polyether polyols are preferably used. Such polyether polyols may be prepared by known processes, for example by anionic polymerisation of alkylene oxides in the presence of alkali metal hydroxides or alkali metal alcoholates as catalysts and with the addition of at least one starter molecule containing from 2 to 8 reactive hydrogen atoms bonded therein, or by cationic polymerisation of alkylene oxides in the presence of Lewis acids, such as antimony pentachloride or boron fluoride etherate. Suitable alkylene oxides contain from 2 to 4 carbon atoms in the alkylene radical. Examples are tetrahydrofuran, 1,3-propylene oxide, 1,2- and 2,3-butylene oxide; ethylene oxide and/or 1,2-propylene oxide are preferably used. The alkylene oxides may be used individually, alternately in succession, or in the form of mixtures. Preference is given to mixtures of 1,2-propylene oxide and ethylene oxide, the ethylene oxide being used in amounts of from 10 to 50% in the form of an ethylene oxide end block (“EO-cap”), so that the resulting polyols have primary OH terminal groups to the extent of over 70%. As the starter molecule water or di- and octa-hydric alcohols, such as ethylene glycol, 1,2- and 1,3-propanediol, diethylene glycol, dipropylene glycol, 1,4-ethanediol, glycerol, trimethylolpropane, etc. may be considered. The polyether polyols, preferably polyoxypropylene-polyoxyethylene polyols, have a (mean) functionality of from 2 to 8, preferably from 2 to 4, particularly preferably from 2.5 to 3.5, and number-average molecular weights of from 500 to 8000, preferably from 800 to 3500.

Suitable polyester polyols may be prepared, for example, from organic dicarboxylic acids having from 2 to 12 carbon atoms, preferably aliphatic dicarboxylic acids having from 4 to 6 carbon atoms, and polyhydric alcohols, preferably diols, having from 2 to 12 carbon atoms, preferably 2 carbon atoms. The dicarboxylic acids which may be considered are, for example: succinic acid, glutaric acid, adipic acid, suberic acid, azelaic acid, sebacic acid, decanedicarboxylic acid, maleic acid, fumaric acid, phthalic acid, isophthalic acid and terephthalic acid. The dicarboxylic acids may be used either individually or in admixture with one another. Instead of the free dicarboxylic acids it is also possible to use the corresponding dicarboxylic acid derivative, such as, for example, dicarboxylic acid mono- and/or di-esters of alcohols having from 1 to 4 carbon atoms, or dicarboxylic acid anhydrides. There are preferably used dicarboxylic acid mixtures of succinic, glutaric and adipic acid in relative proportions of, for example, 20 o 35/35 to 50/20 to 32 parts by weight, and in particular adipic acid. Examples of di- and polyhydric alcohols are ethanediol, diethylene glycol, 1,2- and 1,3-propanediol, dipropylene glycol, 1,3-propanediol, 1,4-butanediol, 1,5-pentanediol, 1,6-hexanediol, neopentyl glycol, 1,10-decanediol, glycerol, trimethylolpropane and pentaerythritol. Preference is given to the use of 1,2-ethanediol, diethylene glycol, 1,4-butanediol, 1,6-hexanediol, glycerol, trimethylolpropane or mixtures of at least two of the mentioned diols, in particular mixtures of ethanediol, 1,5-butanediol and 1,6-hexanediol, glycerol and/or trimethylolpropane. It is also possible to use polyester polyols of lactones, for example 6-caprolactone, or hydroxycarboxylic acids, for example o-hydroxycaproic acid and hydroxyacetic acid.

For the preparation of the polyester polyols, the organic, for example aromatic and preferably aliphatic, polycarboxylic acids and/or polycarboxylic acid derivatives and polyhydric alcohols may be polycondensed without a catalyst or in the presence of esterification catalysts, advantageously in an atmosphere of inert gases, such as, for example, nitrogen, carbon monoxide, helium, argon, and also in the melt at temperatures of from 150 to 300° C., preferably from 180 to 230° C., optionally under reduced pressure, until the desired acid number, which is advantageously less than 10, preferably less than 1, is reached.

According to a preferred preparation process, the esterification mixture is polycondensed at the above-mentioned temperatures to an acid number of from 80 to 30, preferably from 40 to 30, under normal pressure and then under a pressure of less than 500 mbar, preferably from 10 to 150 mbar. As esterification catalysts there may be considered, for example, iron, cadmium, cobalt, lead, zinc, antimony, magnesium, titanium and tin catalysts in the form of metals, metal oxides or metal salts. However, the polycondensation may also be carried out in the liquid phase in the presence of diluents and/or entrainers, such as, for example, benzene, toluene, xylene or chloro-benzene, for the azeotropic distillation of the condensation water.

For the preparation of the polyester polyols, the organic polycarboxylic acids and/or derivatives thereof are polycondensed with polyhydric alcohols advantageously in a molar ratio of 1:1 to 1.8, preferably of 1:1.05 to 1.2. The resulting polyester polyols preferably have a functionality of from 2 to 3, in particular from 2 to 2.6, and a number-average molecular weight of from 400 to 6000, preferably from 800 to 3500.

Polycarbonates containing hydroxyl groups may also be mentioned as suitable polyester polyols. Polycarbonates containing hydroxyl groups those of the type known per se, may be considered, which can be prepared, for example, by reaction of diols, such as 1,2-propanediol, 1,4-butanediol, 1,6-hexanediol, diethylene glycol, tri-oxyethylene glycol and/or tetraoxyethylene glycol, with diaryl carbonates, for example diphenyl carbonate or phosgene.

For the preparation of the polyurethane elastomers there are used, in addition to the higher molecular weight polyhydroxyl compounds, as low molecular weight difunctional chain-lengthening agents, low molecular weight, preferably tri- or tetra-functional crosslinking agents or mixtures of chain-lengthening and crosslinking agents.

Such chain-lengthening and crosslinking agents are used to modify the mechanical properties, in particular the hardness, of the PU elastomers. Suitable chain-lengthening agents, such as alkanediols, dialkylene glycols and polyalkylene polyols, and crosslinking agents, for example tri- or tetra-hydric alcohols and oligomeric polyalkylene polyols having a functionality of from 3 to 4, generally have molecular weights<800, preferably from 18 to 400 and in particular from 60 to 300. There are preferably used as chain-lengthening agents alkanediols having from 2 to 12 carbon atoms, preferably 1, 4 or 6 carbon atoms, for example ethanediol, 1,3-propanediol, 1,5-pentanediol, 1,6-hexanediol, 1,7-heptanediol, 1,8-octanediol, 1,9-nonanediol, 1,10-decanediol and in particular 1,4-butanediol, and dialkylene glycols having from 4 to 8 carbon atoms, for example diethylene glycol and dipropylene glycol, as well as polyoxyalkylene glycols. Also suitable are branched-chained and/or unsaturated alkanediols having generally not more than 12 carbon atoms, such as, for example, 2,2-dimethyl-1,3-propanediol, 2-butyl-2-ethyl-1,3-propanediol, 2-butene-1,4-diol and 2-butyne-1,4-diol, diesters of terephthalic acid with glycols having from 2 to 4 carbon atoms, such as, for example, terephthalic acid bis-ethylene glycol or terephthalic acid bis-1,4-butanediol, hydroxyalkylene ethers of hydroquinone or resorcinol, for example 1,4-di-(β-hydroxyethyl)-hydroquinone or 1,3-(β-hydroxyethyl)-resorcinol, alkanolamines having from 2 to 12 carbon atoms, such as ethanolamine, 2-aminopropanol and 3-amino-2,2-dimethylpropanol, N-alkyldialkanolamines, for example N-methyl- and N-ethyl-diethanolamine, (cyclo)aliphatic diamines having from 2 to 15 carbon atoms, such as 1,2-ethylenediamine, 1,3-propylenediamine, 1,4-but-ylenediamine and 1,6-hexamethylenediamine, isophoronediamine, 1,4-cyclohexamethylenediamine and 4,4′-diaminodicyclohexylmethane, N-alkyl-, N,N′-dialkyl-substituted and aromatic diamines, which may also be substituted at the aromatic radical by alkyl groups, having from 1 to 20 carbon atoms, preferably from 1 to 4 carbon atoms, in the N-alkyl radical, such as N,N′-diethyl-, N,N′-di-sec-pentyl-, N,N′-di-sec-hexyl-, N,N′-di-sec-decyl- and N,N′-dicyclohexyl-, p- or m-phenylene-diamine, N,N′-dimethyl-, N,N′-diethyl-, N,N′-diisopropyl-, N,N′-di-sec-butyl, N,N′-dicyclohexyl-4,4′-diamino-diphenylmethane, N,N′-di-sec-butylbenzidine, methylene-bis(4-amino-3-benzoic acid methyl ester), 2,4-chloro-4,4′-diamino-diphenyhnethane, 2,4- and 2,6-toluylenediamine.

There are preferably used as the polyol component higher-functional polyethers, for example based on glycerol or trimethylolpropane, pentaerythritol, sugars, ethylenediamine or o-toluylenediamine, in conjunction with low molecular weight chain-lengthening agents, such as ethanediol or butanediol, as well as chain regulators, such as monofunctional alcohols. Bifunctional polyethers based on ethylene glycol, propylene glycol or diethylene glycol as well as polyesters in conjunction with higher-functional crosslinking agents, such as glycerol, trimethylolpropane, hexamethylenediamine or isophoronediamine, may also be used. If water or mixtures of water and optionally low molecular weight chain-lengthening agents and/or crosslinking linking agents and/or higher molecular weight polyhydroxyl compounds are used in the second step, then microcellular PU elastomers can thus be prepared. Alternatively, that can be achieved by the use of physical blowing agents.

The thickness of the polyurethane elastomer layers is generally from 0.5 to 4 mm, preferably from 1.0 to 3 mm, particularly preferably from 1.5 to 2.5 mm.

The sandwich structural elements according to the invention may also contain one or more polyurethane foam layers. For the preparation of the foam layer, the same isocyanate and polyol components are preferably used as for the preparation of the solid thermosetting polyurethane layer(s). The foam layer is preferably to have a thickness of from 0.5 to 30 mm, with foam layer thicknesses of from 2 to 20 mm being particularly preferred. Closed-pore foams are preferred.

According to the invention it is not necessary for the foam layer also to contain mica or talcum. The foam layer may, for example, contain fillers other than mica or talcum, for example melamine resins or ground polyurethane waste, or it may be produced without filler. It is preferred, however, for the foam layer also to contain mica or talcum as filler.

The decorative surface layer may be produced from various materials according to the desired properties. Examples are plastics, such as PMMA, ABS, PVC, polycarbonate or ASA, but metals, such as aluminium or steel, or alternatively wood (e.g. veneers) may also be used. The decorative surface layer may form either the front or the back visible surface or both visible surfaces of the sandwich structures according to the invention.

The sandwich structural elements according to the invention are optionally fixed to a substrate. The substrate in question may be, for example, of paper, plastics (e.g. GFRP, ASA, ABS, PVC, PP, PE, Teflon, acrylic resin or epoxy resin, solid or in the form of a film), stone, wood or metal (e.g. steel).

The substrate on which the sandwich structure is produced may be a mould that is to be removed once the sandwich structure has hardened, the mould being provided with a parting agent before the layers are applied. Plastics or metal parts, for example from the automotive sector, are also suitable as substrates.

The substrate is preferably a part of the end product, with which the sandwich structural element forms a composite body. In an embodiment of the invention, the substrate is a PMMA moulding that forms the visible and use surface of a sanitary fitting. It has been found that the sandwich structural elements according to the invention exhibit excellent adhesion to PNIMA mouldings when the latter are used as the substrate for the production of the structural elements layer by layer. To produce the excellent adhesion, it is sufficient to clean the PNIMA surface to be coated with a cloth impregnated with solvent (e.g. ethanol, acetone, ethyl acetate, methanol, isopropanol, toluene or xylene) so that it is free of grease and dust.

The sandwich structures according to the invention may include any desired number of layers. An uneven number of layers is preferred, the outermost layers being solid layers. Particular preference is given to a number of layers of from 3 to 5.

The sandwich structures according to the invention are not limited to structures in which the individual layers are of uniform thickness. Rather, the layers may be of different thicknesses according to requirements; moreover, the thickness of each individual layer may vary. Furthermore, it is not necessary for a layer to extend continuously throughout the structural element. For example, it is possible to control the spray application of the reactive mixture so that islands of foam form in the structural element, which islands are permeated by solid webs that connect the solid layers together.

The invention is not limited to sandwich structures in which the respective layers extend over the entire surface of the structure. Rather, it may be advantageous to provide solid polyurethane webs which permeate the foam layer and confer on the structure particularly good shear stability. Furthermore, it may be advantageous to provide the foam layer with regions of varying foam density, for example by making metering of the blowing agent adjustable.

It is also possible according to the invention to insert reinforcing elements and/or anchoring elements between different coats and/or layers of the sandwich structure. For example, for the purposes of reinforcement, strands or fabrics of glass fibres, carbon fibres, aramid fibres, mineral fibres, synthetic fibres of organic nature or natural fibres may be placed on a coat that has not yet reacted fully and be enclosed in the sandwich element by the subsequent application of a further coat.

The invention also provides a process for the preparation of the sandwich structural elements according to the invention. In that process, the solid thermosetting layers, the elastomer layers and the foam layers are produced by the successive application of a polyurethane reactive mixture to a suitable substrate. The polyurethane reactive mixture used therefor preferably contains finely divided mica or talcum in an amount of from 10 to 55 wt. %, based on the mixture.

The sandwich structures according to the invention are preferably produced by application layer by layer to a substrate, for example by coating, doctor application or spraying, preferably by spraying. The components of the polyurethane reactive mixture, particularly the isocyanate, the polyol mixture containing filler, and optionally separately the blowing agent, are fed in metered amounts to a suitable mixing unit by means of separate pipes, the outlet of the mixing unit being in the form of a spray head. Suitable mixing units are both high-pressure mixing units that operate by the countercurrent injection method, and low-pressure stirring mechanism mixing units; see, for example, G. W. Becker, D. Braun (eds.): “Kunststoff-Handbuch”, Vol. 7, 3rd edition, Carl-Hanser-Verlag, Munich, Vienna 1993, pages 174 to 186. An additional spray device, for example in the form of a compressed air nozzle surrounding the outlet of the mixing unit in a concentric manner, may optionally be provided at the mixing head outlet. The droplets generated by means of the spray device preferably have a diameter of from 0.2 to 2 mm, in particular from 0.5 to 1.5 mm.

Each of the thermoset, elastomer or foam layers may advantageously be produced by the spray application of the reactive mixture in several coats so that, particularly when thicker layers are required, the still liquid, not fully reacted coat is prevented from running off application surfaces that are inclined relative to the horizontal. In that case, application of the successive coats is in each case “wet on wet”, that is to say when the previously applied coat is still in the incompletely reacted state, particularly before the preceding coat in each case has reached the non-tacky state. In order to prevent the not fully reacted coats from running off, thixotropic agents may be added to the reaction mixtures, for example aromatic or aliphatic amines, such as DETDA.

Application of the first coat of a foam layer to the last coat of the underlying layer is preferably also carried out “wet on wet”, that is to say before the solid layer has reached the non-tacky state. The spray application of the first coat of a thermoset or elastomer layer to the last coat of a foam layer can take place, without disadvantage, when the foam layer has already reacted fully, or has reached the non-tacky state.

Application of the layers of the sandwich structure may be carried out by one or more mixing units. In the case of a sandwich structure consisting of substantially identical material, it may be advantageous to provide at least one mixing head in which the reactive mixture components to be supplied can be changed during the application in such a manner that thermosetting polyurethane, polyurethane elastomer and polyurethane foam can be produced alternately from that mixing head.

The sandwich structures according to the invention may also be produced in the form of one-dimensional endless flat elements, by applying the layers on a moving transport belt, optionally to a substrate that is moving on the transport belt and to which the coating adheres. Suitable substrates are structured or unstructured films of paper, plastics or aluminium, or alternatively steel sheets, veneer or wooden boards. Structural elements are produced from such endless sandwich structural elements by sawing or cutting.

In a preferred embodiment, at least one first solid thermosetting polyurethane layer and a first polyurethane elastomer layer are produced by successive application of the reactive composition on a lower transport belt, and at least one further solid thermosetting polyurethane layer is produced on the upper side of the upper transport belt and is brought into contact with the foam layer, which is still in the process of rising, on the lower transport belt by inverting the transport belt before full hardening has taken place.

It is also not necessary according to the invention to produce all the layers of the sandwich structural element by means of successive coatings. Rather, it is possible, for example if a particular surface structure of both sides of the structural element is important, to produce the upper, for example solid, thermosetting layer of the sandwich structural element separately on a separate substrate and apply it, before the non-tacky state has been reached, to the uppermost layer of a sandwich structural element that has been produced separately, before that uppermost layer has reached the non-tacky state.

The invention relates also to the use of the sandwich structural elements according to the invention in sanitary fittings, vehicles, furniture, and in the construction industry. In all those applications, the sandwich structural elements according to the invention are distinguished by high impact resistance even where the element is of small thickness.

With the sandwich structural elements according to the invention it is possible to produce, for example, reinforced sanitary fittings whose visible surfaces consist of acrylic resin or polymethyl methacrylate, for example bathtubs or shower trays. The following structure has proved successful in this respect: in the region of the base of the tub, a solid thermosetting polyurethane layer (L2) (e.g. Baytec® RS massiv, Bayer AG, D-51368 Leverkusen) is applied to the side of the PMMA moulded blank (L1) that is remote from the visible surface; to the layer (L2) there are applied a polyurethane elastomer layer (L3) (e.g. Baytec® Reaktiv, Bayer AG, D-51368 Leverkusen), then a layer of polyurethane foam (L4) (e.g. Baytec® RS Schaum, Bayer AG, D-51368 Leverkusen) and finally a further solid thermosetting polyurethane layer (L5). Typical parameters for the layers are, for example:

L1: wall thickness 0.8-2.5 mm,

L2: layer thickness approx. 3 mm, apparent density approx. 1.3 g/cm³,

L3: layer thickness approx. 2 to 3 mm, apparent density approx. 1.0 g/cm³,

L4: layer thickness approx. 13 mm, apparent density approx. 0.4 g/cm³,

L5: layer thickness approx. 3 mm, apparent density approx. 1.3 g/cm³.

In the region of the rounded areas, where the base of the tub merges into the sides, the thickness of the foam layer is gradually reduced to approximately 6 mm; in the region of the side walls, only layers L2 and L3 are applied. In a less preferred embodiment, layer L3 may be omitted in the region of the base of the tub. The sanitary fittings according to the invention exhibit a markedly increased impact resistance and as a result ensure increased reliability and a reduced risk of injury for the user.

The sandwich structural elements according to the invention are also used in the production of bodies for refrigerated vehicles. Such bodies can be produced from elements in sheet form, which can be produced by the spray process in flat moulds. To that end, there is first introduced into the mould a gel-coat layer (L1) (e.g. based on unsaturated polyester resins or polyurethane), which may have a thickness of, for example, 0.8 mm. That layer subsequently forms a visible surface of the element. A solid thermosetting polyurethane layer (L2), which may have a thickness of, for example, approximately 3 mm, is applied to the layer (L1) by spraying. A polyurethane elastomer layer (L3) is then applied by spraying in a thickness of, for example, approximately 2 mm. That is followed by a further solid thermosetting polyurethane layer (L4), which may have a thickness of, for example, approximately 2 mm. The sheet-like structural element for producing the bodies of refrigerated vehicles is obtained by combining two of the panels so obtained and filling the gap between them with a polyurethane hard foam (L5) in a layer thickness of generally from 1 to 8 cm, for example from 5 to 7 cm, the hard foam having an apparent density in the range of approximately from 30 to 70 g/cm³. A structural element having the layer sequence L1/L2/L3/L4/L5/L4/L3/L2/L1 is thus obtained. The structural elements according to the invention exhibit good heat insulation and excellent impact resistance, so that damage to the inner wall of the structure during loading or as a result of the load's sliding during transportation can largely be avoided. Further advantages of the structural elements according to the invention are that the period of time required for their production is short, and that the elements consist of a uniform material, namely polyurethane, and therefore can be disposed of or sent for recycling as a whole after use.

Elements having an analogous structure can also be used as insulating panels or structural elements in house building, in particular for the building of prefabricated houses.

The sandwich structural elements according to the invention may also be used in the construction sector, for example for the production of doors, garage doors, etc. There are suitable therefor, for example, sheet-like elements having the layer sequence (L1) decorative layer (e.g. veneer or gel-coat based on an unsaturated polyester resin or a polyurethane), (L2) solid thermosetting polyurethane layer (thickness, for example, approximately 3 mm), (L3) polyurethane elastomer layer (thickness, for example, approximately 2 mm), (L4) solid thermosetting polyurethane layer (thickness, for example, approximately 2 mm) and optionally (L5) a further decorative layer. The elements can be produced by the spray method in flat moulds. The increased impact resistance is also of deciding importance in the case of such elements.

Further fields of application of the sandwich structural elements according to the invention are the production of impact-resistant coated vehicle parts (e.g. parts for motor vehicles, parts and bodies for boats, particularly for rowing boats, canoes, kayaks), impact-resistant furniture or impact-resistant floor coverings, and in the field of commercial insulation (e.g. domestic refrigerators, pipes).

### EXAMPLES

Pendulum Impact Tests on Acrylic Bathtubs

The backrest surfaces of acrylic bathtubs having a length of 180 cm, a width of 50 cm and a height of 80 cm were tested. The moulded blank was in each case a deep-drawn PMMA shell having a wall thickness of 1.2 mm. Various reinforcing layers were applied to the moulded blank. Pendulum impact tests were carried out on the resulting tubs in order to determine the fracture resistance.

The pendulum used for the tests consisted of a metal rod 96 cm long, which was suspended to give a pendulum length of 56 cm. At the end of the pendulum there was a hemispherical hammer having a diameter of 55 mm and having a shaft attached perpendicularly to the pendulum axis, in the plane of oscillation, for receiving additional weights, there being provided at the other end of the metal rod an equalising weight so that the metal rod was balanced. The pendulum was suspended at a height of 76 cm above the ground.

In order to carry out the pendulum impact test, the tub was fixed in a mounting beneath the suspended pendulum. The pendulum was locked in the horizontal position, loaded with the desired additional weight, and the lock was then released. After the test, the effect of the impact was measured and the test was optionally repeated with a higher additional weight.

A. GFRP Reinforcement (Comparison)

The base body was reinforced by the spray application of a 3 mm. thick reinforcing layer of glass-fibre-reinforced polyester composite to the side of the moulded blank remote from the visible surface.

| Impact | | |
|---|---|---|
| no. | Pendulum weight [kg] | Damage |
| 1 | 1.9 | — |
| 2 | 2.4 | — |
| 3 | 2.9 | — |
| 4 | 3.4 | — |
| 5 | 3.9 | — |
| 6 | 4.4 | — |
| 7 | 4.9 | — |
| 8 | 5.4 | — |
| 9 | 5.9 | — |
| 10 | 6.4 | 1st superficial impression in the acrylic |
| 11 | 6.9 | no further damage |
| 12 | 7.5 | 40 mm vertical through-crack |
| 13 | 7.5 | circular crack, D = 35 mm |
| 14 | 7.5 | 2nd circular crack, D = 60 mm |
| 15 | 7.5 | impression 50 mm deep |

B. PU Reinforcement (Comparison)

The base body was reinforced by the spray application of a 3 mm thick reinforcing layer of solid thermosetting polyurethane (Baytec® RS massiv, Bayer AG) to the side of the moulded blank remote from the visible surface.

| Impact no. | Pendulum weight [kg] | Damage |
|---|---|---|
| 1 | 1.9 | — |
| 2 | 2.4 | — |
| 3 | 2.9 | audible damage |
| 4 | 3.4 | no further damage |
| 5 | 3.9 | 150 mm vertical crack |
| 6 | 5.9 | vertical crack to 240 mm, 180 mm |
| | | horizontal crack |
| 7 | 5.9 | vertical crack to 270 mm, horizontal |
| | | crack to 210 mm |
| 8 | 5.9 | vertical crack to 310 mm, horizontal |
| | | crack to 210 mm |
| 9 | 5.9 | vertical crack to 350 mm, horizontal |
| | | crack to 250 mm first punched out |
| | | hole and though-crack |

C. Composite Structure According to the Invention

The base body was reinforced by the spray application to the side of the moulded blank remote from the visible surface of a 3 mm thick reinforcing layer of solid thermosetting polyurethane (Baytec® RS massiv, Bayer AG), followed by a 1 mm thick polyurethane elastomer layer (Baytec® Reaktiv, Bayer AG), a 13 mm thick layer of polyurethane foam (Baytec® RS Schaum, Bayer AG) and a further 2 mm thick solid thermosetting polyurethane layer (Baytec® RS massiv, Bayer AG).

| Impact | | |
|---|---|---|
| no. | Pendulum weight [kg] | Damage |
| 1 | 1.9 | — |
| 2 | 2.4 | — |
| 3 | 2.9 | — |
| 4 | 3.4 | — |
| 5 | 3.9 | 1st superficial impression in the acrylic, |
| | | D = 6 mm |
| 6 | 4.4 | no further damage |
| 7 | 4.9 | no further damage |
| 8 | 5.4 | no further damage |
| 9 | 5.9 | no further damage |
| 10 | 6.4 | no further damage |
| 11 | 6.9 | no further damage |
| 12 | 7.5 | no further damage |
| 13 | 8.0 | no further damage |
| 14 | 8.5 | vertical marking in the impression |
| 15 | 9.0 | no further damage |
| 16 | 9.5 | no further damage |
| 17 | 10.0 | no further damage |
| 18 | 10.8 | semi-circular crack from the point of |
| | | impact, D = 180 mm |

What is claimed is:

1. An article comprising a plurality of layers arranged in the sequence of components a) through f) wherein
a) is an optional decorative hard surface layer, and
b) is a solid thermosetting polyurethane layer, and
c) is a crosslinked polyurethane elastomer layer, and
d) is an optional polyurethane foam layer, and
e) is a solid thermosetting polyurethane layer, and
f) is an optional substrate,
each of said a) through f) being bonded to its neighboring components.

2. An article comprising a plurality of layers arranged in the sequence of components a) through f) wherein
a) is an optional decorative hard surface layer, and
b) is a solid thermosetting polyurethane layer, and
c) is a crosslinked polyurethane elastomer layer, and
d) is an optional polyurethane foam layer, and
e) is a solid thermosetting polyurethane layer, and
f) is an optional decorative hard surface layer,
each of said a) through f) being bonded to its neighboring components.

3. The article of claim 1 wherein the polyurethanes (b) and (e) and the polyurethane of (c) are products of reactions having identical isocyanate reactants.

4. A process for preparing the article of claim 1 comprising applying said (b) to said (c) before said (b) has reached a non-tacky state and said layer combination of at least (b) and (c) to said (e) before said layer combination of at least (b) and (c) has reached a non-tacky state.

5. The process of claim 4 comprising applying each of said (b), said (c) and said (e) in the form of plurality of coats by spraying.

6. The article of claim 1 selected from the group consisting of sanitary fitting and body of a refrigerated vehicle.

7. The article of claim 2 selected from the group consisting of sanitary fitting and body of a refrigerated vehicle.
